(19) United States
(12) Patent Application Publication
(10) Pub. No.: US 2026/0368761 A1
(43) Pub. Date: Nov. 19, 2026

(54) AUTOMATIC EXECUTABLE JOURNEY GRAPH GENERATION

(71) Applicant: Adobe Inc., San Jose, CA (US)

(72) Inventors: Jun HE, Fremont, CA (US); Karina Shanti Patel, Danville, CA (US); Yantao Zheng, San Francisco, CA (US); Zeus Courtois, Austin, TX (US)

(21) Appl. No.: 19/212,407

(22) Filed: May 19, 2025

(51) Int. Cl. G06Q 30/0201; G06N 5/022

(52) U.S. Cl. CPC G06Q 30/0201; G06N 5/022

(57) ABSTRACT

Some aspects relate to technologies providing a framework for generating an executable journey graph. In accordance with some aspects, journey graph data is received and a hybrid journey text and graph is generated based on the journey graph data and using one or more artificial intelligence models. The hybrid journey text and graph is formatted for execution to generate an executable journey graph that is executed by a computer system.

### BACKGROUND

Customer journey planning software is used in multi-channel marketing to engage customers across multiple touchpoints, such as email, messaging, notification, and web pages. Customer journey planning involves creating a journey graph of interconnected actions and decisions that guide a customer through specific objectives, such as purchases and service sign-ups. However, designing and managing these customer journey graphs is time-consuming and prone to errors. One particular challenge is that it is difficult to predict and model customer behavior and account for the variety of possible branching paths. Another challenge is that integrating various elements, such as audience demographics and personalized messaging, increases the complexity of the journey graph. An inefficient or incomplete journey graph detracts from the customer experience and can lead to frustration, unreliable data, and lost revenue.

### SUMMARY

Some aspects of the present technology relate to, among other things, using artificial intelligence models, such as knowledge graphs, large language models, and uplift models, to automatically generate executable journey graphs. In accordance with some aspects of the technology described herein, marketing users and other users can use an executable journey graph generation system to automatically generate executable journey graphs. These executable journey graphs can be used by a multi-channel marketing platform to guide customers through a series of interconnected actions and decisions to a final objective such as making a purchase, or signing up for a system or service to receive marketing messages (for example, emails, messages, or in-app messages).

The executable journey graph generation system uses historical journey data such as previously generated journey graphs and/or performance data about how effective those previously generated journey graphs were, to build a knowledge graph that encapsulates that previous journey knowledge. The executable journey graph generation system uses this knowledge graph to obtain data and metadata about relevant past journeys and uses those relevant journeys to generate a prompt to a journey graph generation component. The prompt can be generated using a large language model (LLM). In some aspects, this prompt is a few-shot prompt, thereby providing examples to an artificial intelligence (AI) model and guiding the output. The journey graph generation component of the executable journey graph generation system uses this prompt to generate a hybrid journey text and graph, which is an intermediate representation of the journey graph that combines textual descriptions and graphical representations of the nodes of the graph as well as the relationships between those nodes. The journey graph generation component can also use an LLM to process the prompt and generate the hybrid journey text and graph. The journey graph generation component of the executable journey graph generation system can also use various user inputs and interactions with the journey (for example, using the historical data) to generate the hybrid journey text and graph.

This hybrid journey text and graph is formatted so that it is executable, yielding an executable journey graph. The executable journey graph is evaluated to determine its quality. This evaluation is based on previously generated pairs of manual and automatic journey graphs. A journey graph that meets a minimum quality threshold is provided to the user. A journey graph that does not meet the minimum quality threshold is regenerated. This process continues iteratively until the generated journey graph meets the minimum quality threshold. In this way, more successful variations are promoted for use in a marketing system. For example, journey that increase conversion rates are used while those that do not are regenerated. By improving journey graphs through ideation, hypothesis, generation, and testing, the overall performance and usability of a marketing system is improved.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system for automatically generating an executable journey graph, in accordance with implementations of the present disclosure;

FIG. 2 is a block diagram illustrating a workflow for using a knowledge graph to automatically generate an executable journey graph, in accordance with some implementations of the present disclosure;

FIG. 3 is a block diagram illustrating a workflow for using a custom large language model and/or an uplift model to automatically generate an executable journey graph, in accordance with some implementations of the present disclosure;

FIG. 4 is a block diagram illustrating an example journey graph, in accordance with some implementations of the present disclosure;

FIG. 5 is a block diagram illustrating an example automatically generated journey graph, in accordance with some implementations of the present disclosure;

FIG. 6 is a flow diagram showing an example process for automatically generating a journey graph, in accordance with some implementations of the present disclosure;

FIG. 7 is a flow diagram showing an example process for automatically generating a journey graph, in accordance with some implementations of the present disclosure;

FIG. 8 shows a flow diagram depicting an algorithm as a step-by-step procedure for training a machine-learning model, in accordance with some implementations of the present disclosure;

FIG. 9 shows an example of a computing device, in accordance with some implementations of the present disclosure; and

FIG. 10 shows an example of an automatic executable journey graph generation apparatus, in accordance with some implementations of the present disclosure.

### DETAILED DESCRIPTION

Various terms are used throughout this description. Descriptions of some terms are included below to provide a clearer understanding of the ideas disclosed herein.

As used herein, a “journey graph” is generally a graph of interconnected actions and decisions that guide a customer through specific objectives, such as purchases and service sign-ups. In some instances, a journey graph is referred to as a journey map. A journey graph is typically a directed acyclic graph (DAG).

As used herein, an “executable journey graph” is a journey graph that is formatted so that it can be executed in journey planning software, in multi-channel marketing systems, or in other purchase and sale systems. Typically, an executable journey graph is represented using a data representation and interchange format, such as JavaScript™ Object Notation (JSON).

As used herein, a “hybrid journey graph and text” is an intermediate representation of a journey graph that includes both graph elements, such as nodes and edges, and textual descriptions of those graph elements. A hybrid journey text and graph is generally not executable, and must be formatted for execution by translating the hybrid journey text and graph into an executable format.

As used herein, an “artificial intelligence model” is a term that encompasses any one of several artificial intelligence models including, but not limited to, knowledge graphs, large-language models (LLMs), uplift models, neural networks, and other such models. In some instances, a plurality of artificial intelligence models can be used in combination to perform aspects of the present technology.

As used herein, a “knowledge graph” is a representation of interconnected data and/or knowledge and the relationships between such data. A knowledge graph can be used to represent interconnected data such as journey knowledge, which can include historical journey graph data, journey performance indicators, and/or in-journey behavior data. In some instances, a knowledge graph comprises nodes that represent knowledge and edges that represent connections between those nodes.

As used herein, a “large language model” is an artificial intelligence or machine learning model that can understand and generate human language. A large language model, also referred to herein as an LLM, is trained on a large corpus of language data. LLMs can be open source or closed, and have a variety of capabilities. In some instances, a large language model is used to generate formatted data such as a hybrid journey graph and text, as described herein. Typically, an LLM can be used in conjunction with other artificial intelligence or machine learning models.

As used herein, an “uplift model” is a predictive model that is used in marketing to directly model the incremental impact of an action or treatment on the behavior of an individual user.

As used herein, “journey graph data” is data and/or metadata pertaining to current and past performance of journey graphs. Journey graph data includes historical journey graph data, journey performance indicators, in-journey behavior data, and other such data. In some instances, journey graph data includes current journey graph data, which is journey graph data for a currently executing journey graph.

As used herein, “historical journey graph data” is data about previously executed journey graphs. This data can include past performance, user interactions, errors, conversion rates, and other such data and/or metadata.

As used herein, “journey performance indicators” are performance indicators about how a user interacts with a journey graph and indicators about the efficiency of a particular journey graph. Journey performance indicators are also referred to as key performance indicators, or KPI.

As used herein, “in-journey behavior data” is data and/or metadata about a user’s interaction with a journey graph. In-journey behavior data can overlap with other journey data.

As used herein, a “prompt” is a prompt to an executable journey graph generation system that causes the system to generate an executable journey graph. In some instances, a prompt is provided by a user. In some instances, a user provides input that is used to generate the prompt. In some instances, a prompt is generated using one or more artificial intelligence models such as knowledge graphs and LLMs.

As used herein, “user inputs and interactions” are a user’s input into an executable journey graph generation system that can inform the generation of an executable journey graph. One example of user inputs and interactions is a plain text description of the desired executable journey graph that is used to generate the prompt. Another example of user inputs and interactions are various interactions that are used to iterate on and/or improve an executable journey graph.

As used herein, a “determined quality threshold” is a pre-determined quality threshold that is used by an executable journey graph generation system to determine whether a generated executable journey graph is of a minimally acceptable quality. An executable journey graph that meets or exceeds a determined quality threshold can be provided for execution in a system such as a multi-channel marketing system. An executable journey graph that does not meet or exceed a determined quality threshold may be discarded and/or regenerated. A determined quality threshold can be based on one or more quality metrics, which can be derived from journey graph data.

As used herein, “quality metrics” are assorted measures of the quality of an executable journey graph. Quality metrics can range from efficiency of a journey graph, conversion rates of the journey graph, errors (or lack thereof) that occur when the journey graph is executed, and so on. A user of an executable journey graph generation system can provide quality metrics and can also set a minimum quality threshold for generated executable journey graphs.

As used herein, an “indication of the quality of an executable journey graph” is a discrete value that indicates the quality of a journey graph. This indication can be based on quality metrics. This indication can also be compared to a determined quality threshold and that comparison can be used to determine whether a generated executable journey graph is acceptable for use in a production system such as a multi-channel marketing system.

As used herein, “tuning a quality evaluation component” is a process whereby a quality evaluation component is adjusted to provide a more accurate and relevant method for evaluating the quality of a generated executable journey graph. Tuning a quality evaluation component typically compares original and generated journey graph pairs to determine how well an executable journey graph generation system is performing and using that determination to adjust how the quality of an executable journey is evaluated.

As used herein, “an original and generated journey graph pair” is a pair of journey graphs that includes a journey graph (the original) that has been previously verified and/or validated and a new generated journey graph for the same journey. By comparing these two graphs, quality metrics can be determined and improved. The original journey graph can also be referred to as a “good” or “known” journey graph.

As used herein, “performance insights derived from analyzing user interactions with the executable journey graph” are AI derived insights that can be used to propose architecture modifications to an executable journey graph. These performance insights are derived from changing conditions and the proposed architecture modifications can be used to update an existing executable journey graph. In some instances, these proposed architecture modifications are automatically applied. In some instances, these proposed architecture modifications are applied only after they are approved by a user.

As used herein, a “multi-channel marketing system” is a system that uses multiple channels such as email, social media, messaging, websites, etc., to reach and engage with customers. A multi-channel marketing system is software that allows marketers to engage with uses in any of the preferred channels.

As used herein, a “journey planning system” is a software system that enables marketers to perform journey planning, generate executable journey graphs, deploy those executable journey graphs, evaluate the performance of those executable journey graphs, and adjust the executable journey graphs based on that evaluation.

As used herein, a “few-shot prompt” is a prompt to an AI model that includes context for the prompt with the prompt in the form of examples. A few-shot prompt provides two or more examples. A few-shot prompt provides these examples to the AI model to guide the model’s output. A few-shot prompt provides two or more examples to provide context to guide the output. Few-shot prompting is one technique for providing context and other methods of providing context can be used. Few-shot prompting differs from zero-shot (no examples) and one-shot (one example) prompting.

### Overview

Performing customer journey orchestration is an important element of modern marketing, enabling businesses to engage customers across diverse touchpoints including, but not limited to, email, messaging, in-app notifications, and web experiences, while personalizing interactions for each customer segment. Customer journey planning typically involves creating interconnected actions and decisions that guide customers toward specific objectives, such as purchases, sign-ups, or increased engagement. However, manually designing and managing these complex journeys is time-consuming and prone to errors. For example, marketers face the challenge of predicting customer behavior, defining branching paths, and integrating various elements such as audience qualifications, personalized messaging, decision logic, and timing controls. Even manually generating journey graphs can be a complex task, requiring balancing a wide variety of different branches and tasks. Additionally, manual generation of journey graphs can require considerable technical expertise, requiring a familiarity with both marketing techniques and various software systems that are used to specify a customer journey and generate an executable journey graph that can be executed by a marketing system of a website to guide a customer journey. Manually generating journey graphs typically requires the specification of a customer journey for a particular marketing task (for example, sign-ups), the translation of that specification into a technical language, the implementation of that translated specification, and then iterative testing based on performance data. Since it can take days or even weeks to recognize issues with the manually generated journey graph, a great deal of positive results can be lost. For example, if a customer cannot use a received email to sign up for a website, and ten-thousand emails went out, that could result in the loss of ten-thousand potential sign-ups.

As such, systems have been developed to facilitate and streamline the creation of customer journey graphs, to partially automate customer journey design by, for example, using graphical systems to layout the customer journey graph. Such systems, however, rely on manual inputs, requiring marketers to carefully map out various journey stages and can still require a great deal of technical knowledge to translate the mapped journey into an executable journey graph. Again, this complexity and high technical barrier increases the likelihood of errors, making it challenging to adapt to real-time customer behavior changes in a timely manner. Additionally, there is a lack of full automation to improve the usability of these systems. While data-driven marketing has evolved, many journey planning tools still depend on manual or partially automated designs. The absence of automated systems that generate journey graphs using historical performance data limits optimization efficiency due to the delay in incorporating the journey data into a new design. These manual and partially automatic tools are not adapted to respond to rapidly changing events and behaviors. As described below, rapidly changing customer behaviors, driven by events like website visits or social media engagement, necessitate agile systems that can adapt without significant manual intervention. Current solutions often have delayed responses to these critical engagement opportunities and, when manually generated, can miss them entirely. These existing tools also have limited options for personalization and flexibility. Creating personalized journeys for every customer segment is complex, requiring manual configuration of qualifications and messaging. Doing this manually for each customer group is complex and often prohibitively expensive but not having a customized personal journey reduces customer engagement. Existing systems typically do not offer AI-driven recommendations based on past performance, leaving marketers to rely on trial and error or generating a very standardized experience.

Aspects of the technology described herein automatically generate executable journey graphs, enabling automatic generation of journey graphs that express the complexity of the user journey. Automatically generated executable journey graphs can also be refined so that they can represent a user journey in a simpler form by reducing redundant pathways and removing unnecessary complexity from the resulting journey graph. These automatically generated executable journey graphs can be quickly updated as events and behaviors change by receiving notifications of those changed events and behaviors and incorporating those notifications to automatically regenerate the executable journey graph, allowing quick response to such event and behavioral changes. As an example, if an executable journey graph includes a pathway that is predicated on a customer redeeming an email offer, and that offer expires, the executable journey graph generation system described herein can automatically regenerate the executable journey graph, removing that now redundant pathway from the journey graph. Similarly, automatically generated executable journey graphs can be easily personalized, incorporating past performance and the preferences of users into the customer journey experience so that, for example, if a customer or group of customers prefers a certain type of communication, such as email, that preference is accounted for when automatically generating the executable journey graph by using that preference to train the various AI models. The executable journey graph generation system described herein combines machine learning techniques with marketing data, real-time events, and user experiences and preferences to automatically generate executable journey graphs by using the marketing data, real-time events, and/or user experiences and preferences to train the AI models described herein (for example, the knowledge graph, the custom LLM, and/or the uplift model) and using those trained AI models to generate the executable journey graph. The executable journey graph generation system learns from historical data (for example, of past journeys and/or of previously generated journey graphs) by retrieving that historical data from a data store and using that historical data to train the AI models, as described herein. The historical data is then used by the system to generate optimized journey paths to journey objectives, such as conversion, purchase, sign-up, retention, and/or other objectives. As an example, if historical data shows that SMS messaging never results in sign-up, the executable journey graph generation system incorporates this historical data into the generation algorithms described herein, considering that data as a preference when automatically generating an executable journey graph. One method of incorporating this historical data into the generation algorithms described herein uses a knowledge graph, which represents this historical data, as well as the user preferences described above, as a rapidly searchable graph representation of this data, as described herein.

Other artificial intelligence systems and models can be used to improve the quality of an executable journey graph. For example, historical journey graph data and in-journey behavior data such as data about how a customer progressed through a particular journey can be used to train and deploy a custom LLM and/or an uplift model using training methods described herein. A custom LLM can be trained starting from a general (or off-the-shelf) LLM and using the historical journey graph data to enhance that model. An uplift model is trained to consider the impact of a particular action, such as a response to marketing communications, on a customer journey. Training a custom LLM and/or an uplift model using historical journey graph data and in-journey behavior data enables the executable journey graph generation system to incorporate that data when automatically generating an executable journey graph by incorporating those trained models into the generation algorithms. These trained models can be used instead of, or in conjunction with, a knowledge graph, to generate the hybrid journey text and graph using the journey graph generation component of the executable journey graph generation system, described below. A marketing user can use the executable journey graph generation system described herein interactively, and can iteratively refine a journey through different variations, promoting journey graphs and subsets of journey graphs that improve the marketing objectives. These preferences generated during iteration can also be incorporated into the knowledge graph (by adding or removing knowledge graph nodes), the custom LLM (by retraining the custom LLM using the preferences), and/or the uplift model (by retraining the uplift model using the preferences to generate new impact analysis. The executable journey graph generation system described herein can also operate automatically (for example, without the intervention of a marketing user), monitoring in-journey data, detecting problems, generating variations, testing those variations, and promoting those variations that, for example, improve user engagement or conversion.

In accordance with some aspects, the executable journey graph generation system described herein automatically generates executable journey graphs that have optimized journey paths to journey objectives, using historical journey data and/or metadata. The executable journey graph generation system leverages AI to generate journey graphs by analyzing historical designs and performance metrics by using journey data to train or retrain various AI models including, but not limited to, knowledge graphs, custom LLMs, and/or uplift models and using those trained models to generate executable journey graphs. This automation reduces manual effort while optimizing customer interactions for marketing objectives, such as conversions and engagement. In accordance with some aspects, the executable journey graph generation system uses text-based input for customization and personalization by, for example, using an LLM to process the natural language of the text-based input and generate a prompt to the executable journey graph generation system. Marketers can provide text-based prompts specifying audience qualifications, marketing strategies, and/or objectives, and these inputs guide the system to create tailored journey graphs aligned with strategic goals by converting them into usable prompts to the executable journey graph generation system using, for example, an LLM. As described above, in accordance with some aspects, the executable journey graph generation system integrates historical data into the journey planning using trained AI systems such as a knowledge graph, a custom LLM, and/or an uplift model, thereby enhancing the accuracy and efficiency of the journey. By incorporating historical journey graph designs and associated performance data using the AI models, the executable journey graph generation system ensures that generated journey graphs are informed by past successes and account for past failures. This improves the likelihood of achieving desired outcomes. In accordance with some aspects, the executable journey graph generation system has an AI-driven architecture as described herein that can respond quickly to changes in conditions or preferences by updating the AI models to include those changes in conditions and/or preferences. In addition to generating new journey graphs, the executable journey graph generation system can propose modifications to an executable journey graph based on performance insights that are derived from changing conditions and use those modifications to update an existing journey graph again using those trained AI models. In some aspects, recommendations for proposed architecture modifications are automatically performed to regenerate an executable journey graph. In some aspects, these recommendations for proposed architecture modifications are subject to marketer review and approval, maintaining a balance between AI-driven optimization and human oversight.

Aspects of the technology described herein provide a number of improvements over existing technologies. For example, the executable journey graph generation system enhances scalability and efficiency of journey graphs and journey graph generation by adding new pathways to a journey graph when needed, by removing outdated pathways, and/or by combining pathways and reorganizing decision nodes to more efficiently generate an executable journey graph. By significantly reducing the effort required to specify a journey graph to a text-based prompt, a user can use the system described herein to rapidly generate and iterate on candidate journey graphs by processing that text and generating an efficient prompt to the executable journey graph generation system using, for example, an LLM. This significantly reduces both the computing resources and the human resources required to generate usable journey graphs. This scalability and efficiency also reduce resource usage by enabling rapid regeneration of existing journey graphs in response to changing conditions as opposed to generating a new journey graph each time these conditions change. This scalability and efficiency can significantly reduce the use of computing resources both in the generation phase and in the performance phase, when an executable journey graph is used in a production phase. Additionally, a more efficient journey graph more efficiently uses computing resources by avoiding redundant pathways, combining pathways, and reorganizing decision nodes to more efficiently guide a customer through the journey.

In another example of the improvements over existing technologies, the executable journey graph generation system provides objective-driven personalization of executable journey graphs by incorporating personal preferences into the AI models used by the executable journey graph generation system, as describe herein. By utilizing historical performance data and advanced modeling and incorporating that data into the trained AI models, the executable journey graph generation system generates journeys optimized for specific marketing objectives, such as conversions, engagement, or retention. Additionally, customizable text-based inputs ensure journey designs align with brand goals, audience segmentation, and strategic priorities while processing of those text-based inputs to generate usable prompts to the executable journey graph generation system using, for example, an LLM, ensures efficient use of the system and better utilization of computing resources. As such, a better user experience results, yielding more efficient journey paths to the stated objectives and greater engagement and retention. This improved experience reduces the use of computing resources for each user by providing a more streamlined and pleasant experience for that user.

In another example of the improvements over existing technologies, the executable journey graph generation system uses data-driven insights to generate executable journey graphs. These data-driven insights are used to train the AI models such as the knowledge graph, the custom LLM, and/or the uplift model, and these models are used by the executable journey graph generation system to generate a data-driven executable journey graph. This improves the likelihood of a successful journey by analyzing and applying insights from previous journeys and their performance metrics and incorporating those insights into the various AI models. Such performance data is continuously integrated into the executable journey graph generation system so that performance data from generated graphs is fed back into the system, enabling iterative improvements of the models used by the executable journey graph generation system and, accordingly, better decision making over time. Again, this reduces the use of computing resources and continuously improves the quality and efficiency of customer experiences.

In another example of the improvements over existing technologies, the executable journey graph generation system uses AI to improve decision making processes by incorporating performance analytics into the AI models described herein. For example, the executable journey graph generation system can suggest journey graph modifications based on incorporating performance analytics into the AI models, providing marketers with actionable insights for better outcomes. These suggested journey modifications can be automatically applied or can be evaluated and incorporated under user supervision. By identifying potential issues and suggesting modifications, the executable journey graph generation system can avoid costly and computationally expensive monitoring of every aspect of a customer journey.

In another example of the improvements over existing technologies, the executable journey graph generation system provides an enhanced user experience for both the marketing user and the customers. For example, the marketing user can use text-based input to generate new customer journeys and the customer can have their preferences incorporated into the AI models, as described herein, to generate a better, more preferred, customer journey. The executable journey graph generation system simplifies complex journey planning tasks through intuitive text-based inputs as described herein, making it possible to make such journey data accessible to marketers without extensive technical expertise. Additionally, the ability to validate, refine, and deploy journey graphs quickly ensures that customer experiences remain relevant and impactful. This reduces lost opportunities and better uses computational resources.

The executable journey graph generation system described herein addresses challenges in scalability, optimization, and data integration, enabling marketers to create highly effective and personalized customer journeys, while reducing computational costs, human and computational time, and human effort and providing an improved and more efficient customer experience. For example, the executable journey graph generation system can use text-based inputs from marketing users, allowing them to specify the marketing problem in natural language terms such as “generate a customer journey that incorporates SMS, email, and conventional mail, allows special sign-ups for members of our customer loyalty program, and ends in one month.” This text-based input is analyzed by the executable journey graph generation system using, for example, an LLM, and an appropriate prompt to the executable journey graph generation system is generated. This removes the requirement of the marketing user to even form the request in a restrictive format. The executable journey graph generation system then receives the LLM-generated prompt and uses various AI models such as a knowledge graph, a custom LLM, and/or an uplift model to generate the executable journey graph. These AI models are trained using historical journey data, in-journey data, customer preferences, and/or other such data to generate an executable journey graph, thereby removing the requirement of manual translation of the journey graph while incorporating the data. This generated executable journey graph is compared against other journey graphs to determine its efficiency and efficacy. Effective journey graphs are deployed to the marketing system while less effective journey graphs can be iteratively improved. Additionally, since the resulting executable journey graph is automatically generated, it can also be updated as new marketing data is received, allowing rapid response to changes in a market. The resulting automatically generated journey graph is thus scalable and optimized, and can incorporate new data rapidly and efficiently, enabling marketers to easily create highly effective and personalized customer journeys. This considerably reduces computational costs, human and computational time, and human effort and provides an improved and more efficient customer experience.

### Example System and Methods for Automatically Generating an Executable Journey Graph

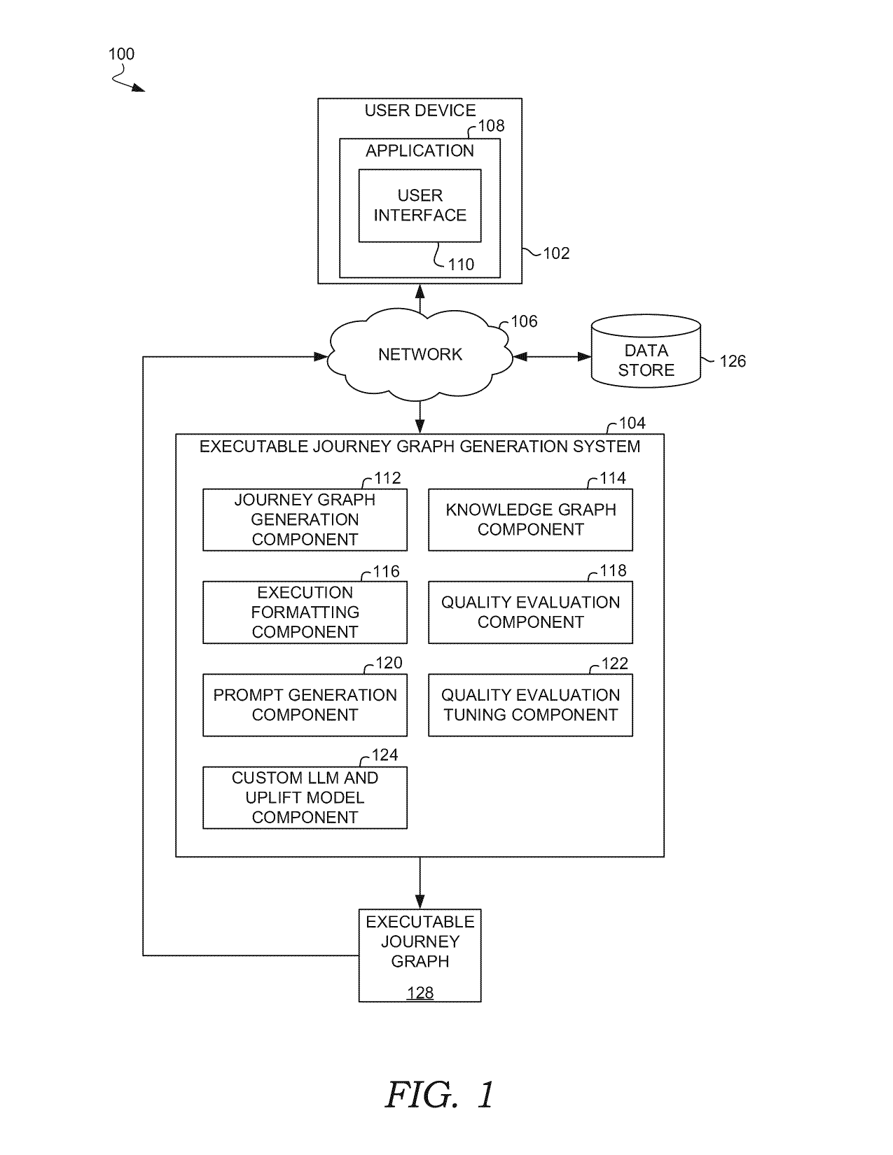

With reference now to the drawings, FIG. 1 is a block diagram illustrating an exemplary system 100 for automatically generating an executable journey graph, in accordance with implementations of the present disclosure. It should be understood that this and other arrangements described herein are set forth only as examples. Other arrangements and elements (for example, machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

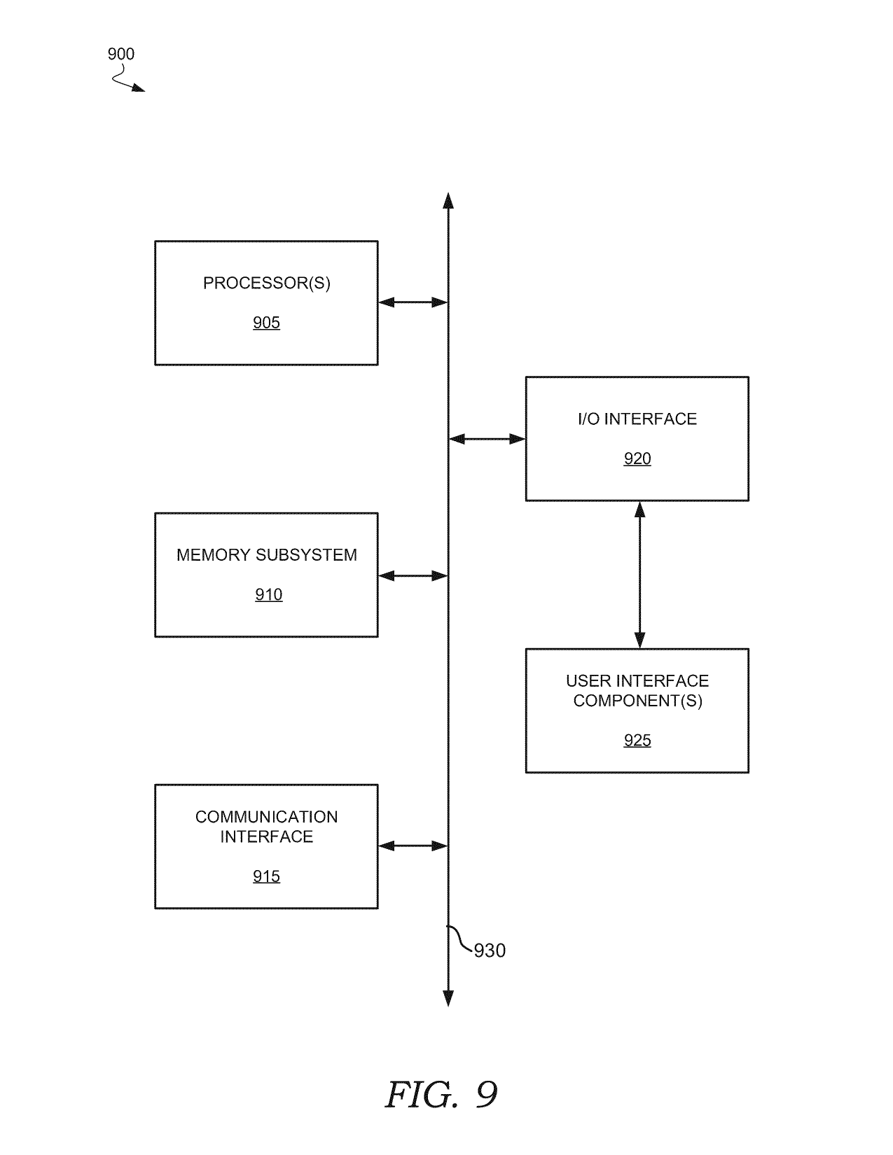

The system illustrated in block diagram 100 is an example of a suitable architecture for implementing certain aspects of the present disclosure. Among other components not shown, the system illustrated in block diagram 100 includes a user device 102 and an executable journey graph generation system 104. Each of the user device 102 and the executable journey graph generation system 104 shown in FIG. 1 can comprise one or more computer devices, such as the computing device 900 of FIG. 9, described below. As shown in FIG. 1, the user device 102 and the executable journey graph generation system 104 communicates via a network 106, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system illustrated in block diagram 100 within the scope of the present technology. Each device or server may comprise a single device or multiple devices cooperating in a distributed environment. For instance, the executable journey graph generation system 104 may be provided by multiple server devices collectively providing the functionality of the executable journey graph generation system 104, as described herein. Additionally, other components not shown may also be included within the environment.

The user device 102 is a client device on the client-side of the operating environment illustrated in block diagram 100, while the executable journey graph generation system 104 is on the server-side of the operating environment illustrated in block diagram 100. The executable journey graph generation system 104 can comprise server-side software designed to work in conjunction with client-side software on the user device 102 so as to implement any combination of the features and functionalities discussed in the present disclosure. For example, the user device 102 can include an application 108 for interacting with the executable journey graph generation system 104. The application 108 is, for instance, a web browser or a dedicated application for providing functions, such as those described herein. This division of an operating environment illustrated in block diagram 100 is provided to illustrate one example of a suitable environment. There is no requirement for each implementation that any combination of the user device 102 and the executable journey graph generation system 104 remain as separate entities. While the operating environment illustrated in block diagram 100 illustrates a configuration in a networked environment with a separate user device 102 and executable journey graph generation system 104, it should be understood that other configurations is employed in which aspects of the various components are combined. For instance, in some aspects, aspects of the executable journey graph generation system 104 is implemented in part or in whole by the user device 102.

In some configurations, the application 108 can comprise a user interface 110. In some configurations, the user interface 110 provides one or more user interfaces to a user of a device, such as the user device 102 for interacting with the executable journey graph generation system 104. In some instances, the user interface 110 is presented on the user device 102 via the application 108, which is a web browser or a dedicated application for interacting with the executable journey graph generation system 104. For instance, the user interface 110 can provide user interfaces for, among other things, receiving input from a user and providing responses to the user. It should be noted that, while the user interface 110 is shown as an element of application 108, in some embodiments, the executable journey graph generation system 104 further includes a user interface component (not shown in FIG. 1) that provides one or more user interfaces for interacting with the executable journey graph generation system 104. In some aspects, not shown in FIG. 1, a user interface component provides one or more user interfaces to a user device, such as the user device 102 via the application 108.

The user device 102 can comprise any type of computing device capable of use by a user. For example, in one aspect, a user device is of the type of computing device 900 described in relation to FIG. 9 herein. By way of example and not limitation, the user device 102 may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user may be associated with the user device 102 and may interact with the executable journey graph generation system 104 via the user device 102.

In some configurations, the executable journey graph generation system 104 is implemented, at least in part, using artificial intelligence models that generate responses to user queries through natural language interaction. In such instances, the executable journey graph generation system 104 can use artificial intelligence and machine learning algorithms to understand user queries, interpret context, and generate responses by accessing relevant information from various sources. In at least one embodiment, the executable journey graph generation system 104 uses generative models such as those described herein to understand user queries, interpret context, and generate and optimize web forms using systems, methods, operations, and techniques such as those described herein.

As shown in FIG. 1, the executable journey graph generation system 104 comprises a journey graph generation component 112, a knowledge graph component 114, an execution formatting component 116, a quality evaluation component 118, a prompt generation component 120, a quality evaluation tuning component 122, and/or a custom LLM and uplift model component 124. The components of the executable journey graph generation system 104 are in addition to other components that provide further additional functions beyond the features described herein. The executable journey graph generation system 104 is implemented using one or more server devices, one or more platforms with corresponding application programming interfaces, cloud infrastructure, and the like. While the executable journey graph generation system 104 is shown as separate from the user device 102 in the configuration of FIG. 1, it should be understood that in other configurations, some or all of the functions of the executable journey graph generation system 104 are provided on the user device 102. Additionally, in some configurations, one or more of the components of the executable journey graph generation system 104 shown in FIG. 1 (for example, the journey graph generation component 112, the knowledge graph component 114, the execution formatting component 116, the quality evaluation component 118, the prompt generation component 120, the quality evaluation tuning component 122, and/or the custom LLM and uplift model component 124) are provided by the user device 102 and/or another device not shown in FIG. 1. In some configurations, the components of the executable journey graph generation system 104 are provided by a single entity or by multiple entities.

In some aspects, the functions performed by the components of the executable journey graph generation system 104 are associated with one or more applications, services, or routines. In particular, such applications, services, or routines may operate on one or more user devices and servers, may be distributed across one or more user devices and servers, or may be implemented in the cloud. Moreover, in some aspects, these components of the executable journey graph generation system 104 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein is performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in the example system illustrated in block diagram 100, it is contemplated that in some aspects, functionality of these components is shared or distributed across other components.

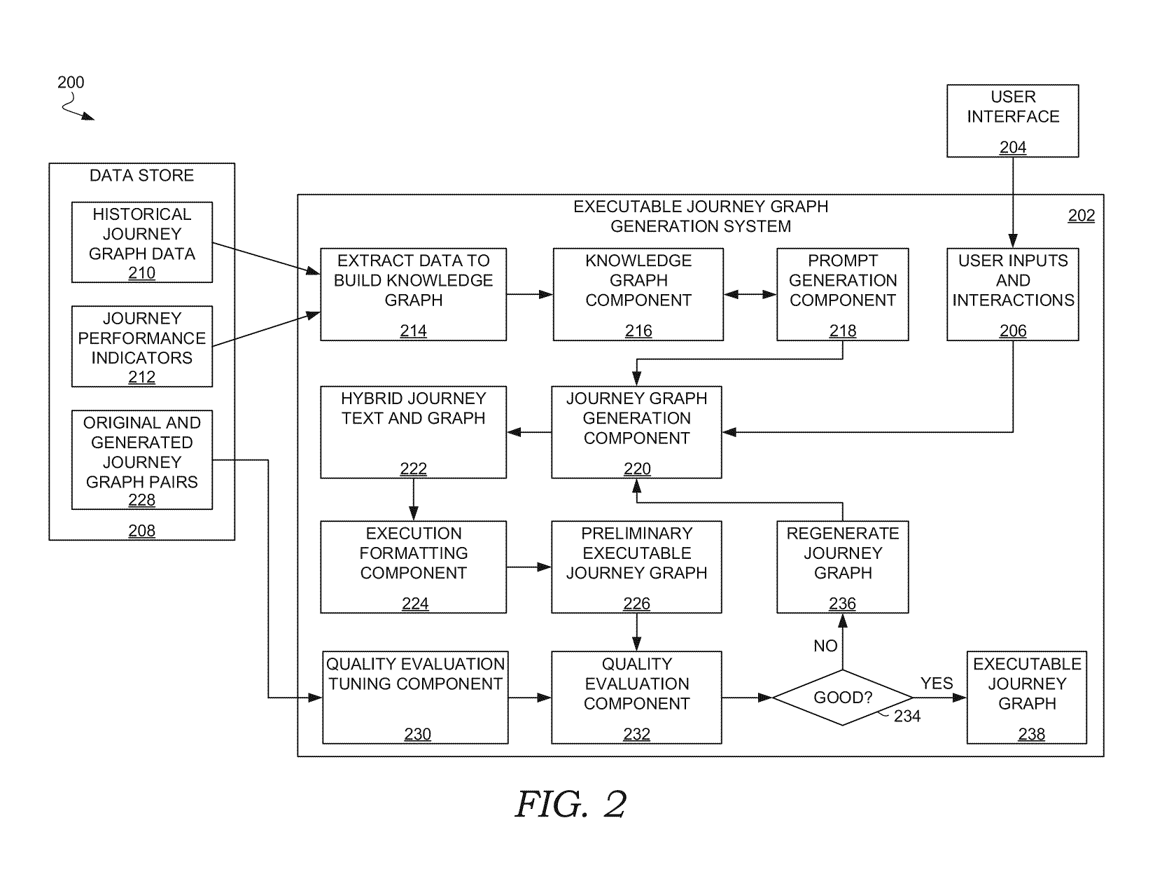

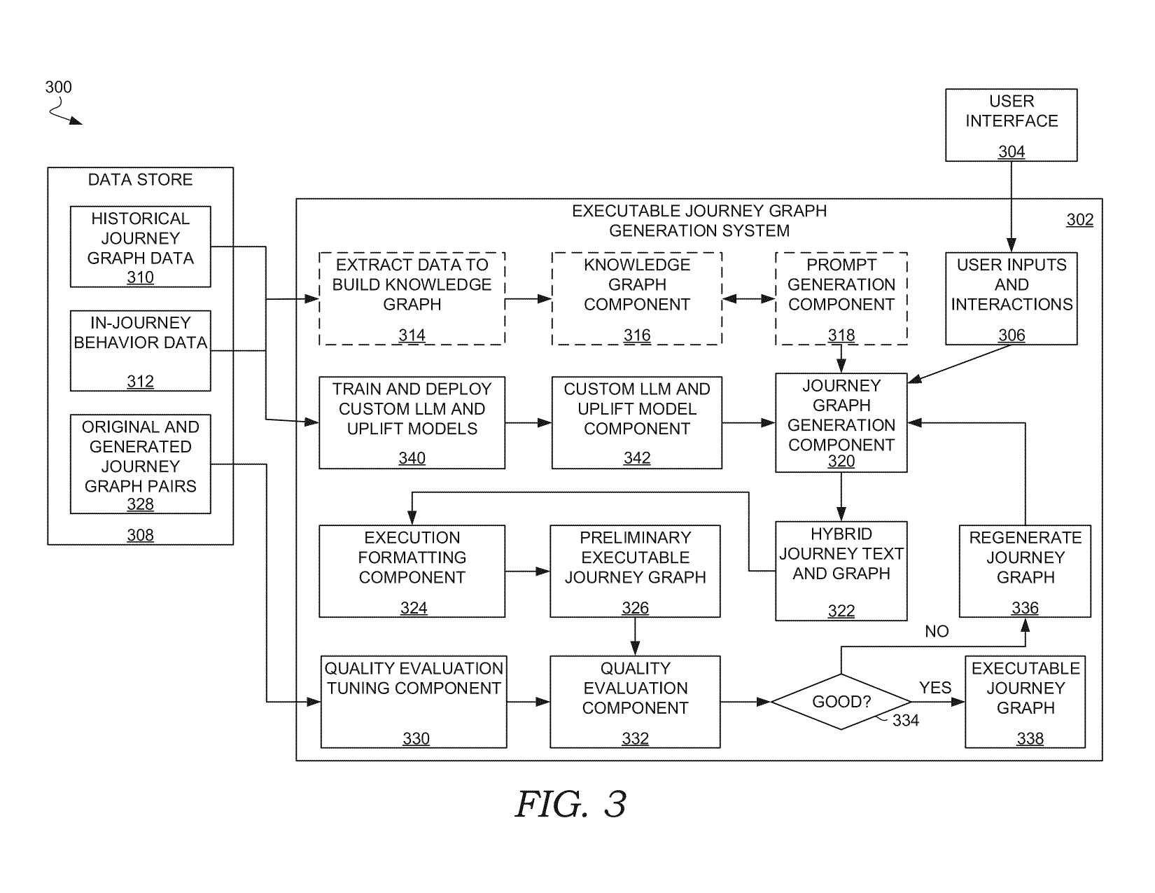

In some aspects, the executable journey graph generation system 104 uses the journey graph generation component 112 to generate a hybrid journey text and graph representation of a candidate journey graph, which is an intermediate representation of the journey graph that combines textual descriptions and graphical representations of the nodes of the graph as well as the relationships between those nodes, as described above. The journey graph generation component 112 typically receives a prompt from the prompt generation component 120, described below, to generate the hybrid journey text and graph representation of a candidate journey graph. The journey graph generation component 112 can also receive user inputs and/or interactions, as described below in connection with FIG. 2 to generate the hybrid journey text and graph representation of a candidate journey graph. The journey graph generation component 112 provides this hybrid journey text and graph representation of a candidate journey graph to the execution formatting component 116, also described below. In some aspects, the journey graph generation component 112 can also receive a request to regenerate an executable journey graph if, as described below, the quality evaluation tuning component 122 determines that a candidate executable journey graph does not meet or exceed a determined quality threshold. As described herein, the journey graph generation component 112 is used by, or in conjunction with, a number of other components of the executable journey graph generation system 104 to automatically generate an executable journey graph. Further details of the journey graph generation component 112 are described below, at least in connection with FIGS. 2 and 3.

In some aspects, the executable journey graph generation system 104 uses the knowledge graph component 114 to generate a knowledge graph that is used by the prompt generation component 120 to generate a prompt. This prompt is used by the journey graph generation component 112 to generate the hybrid journey text and graph representation of a candidate journey graph, as described above. The knowledge graph component 114 uses historical journey graph data and journey performance indicators (both as described in connection with FIG. 2) to generate, store, and update the knowledge graph. The knowledge graph component 114 uses the data store 126 to obtain the historical journey graph data and journey performance indicators and also uses the data store 126 to store and update the knowledge graph. As used herein, the data store 126 is any device or system configured to store and retrieve data such as those described herein. The knowledge graph is generated from the historical journey graph data and journey performance indicators and it represents the previous journey data as a knowledge graph, where data about journey entities and the relationships between them can be quickly accessed. As described herein, the knowledge graph component 114 is used by, or in conjunction with, a number of other components of the executable journey graph generation system 104 to automatically generate an executable journey graph. Further details of the knowledge graph component 114 are described below, at least in connection with FIGS. 2 and 3.

In some aspects, the executable journey graph generation system 104 uses the execution formatting component 116 to format the hybrid journey text and graph representation of a candidate journey graph generated by the journey graph generation component 112. The execution formatting component 116 formats the hybrid journey text and graph representation of a candidate journey graph so that it can be executed by a journey optimizer system and evaluated for system quality. As described herein, the execution formatting component 116 is used by, or in conjunction with, a number of other components of the executable journey graph generation system 104 to automatically generate an executable journey graph. Further details of the execution formatting component 116 are described below, at least in connection with FIGS. 2 and 3.

In some aspects, the executable journey graph generation system 104 uses the quality evaluation component 118 to evaluate the quality of the executable journey graph obtained from the execution formatting component 116. The quality evaluation component 118 evaluates the executable journey graph using one or more quality metrics, collectively referred to herein as a “quality threshold.” If the quality evaluation component 118 determines that the executable journey graph provided by the execution formatting component 116 does meet or exceed a determined quality threshold (that, for example, comprises the one or more quality metrics), the executable journey graph is provided as the output executable journey graph 128, as described below. If the quality evaluation component 118 determines that the executable journey graph provided by the execution formatting component 116 does not meet or exceed a determined quality threshold, the executable journey graph sends a request to the journey graph generation component 112 to regenerate the hybrid journey text and graph representation of a candidate journey graph or to generate a new hybrid journey text and graph representation of a candidate journey graph. As described herein, the quality evaluation component 118 is used by, or in conjunction with, a number of other components of the executable journey graph generation system 104 to automatically generate an executable journey graph. Further details of the quality evaluation component 118 are described below, at least in connection with FIGS. 2 and 3.

In some aspects, the executable journey graph generation system 104 uses the prompt generation component 120 to generate a prompt to the journey graph generation component 112. The prompt generation component 120 uses the knowledge graph component 114 to generate the prompt, as described above. As described herein, the prompt generation component 120 is used by, or in conjunction with, a number of other components of the executable journey graph generation system 104 to automatically generate an executable journey graph. Further details of the prompt generation component 120 are described below, at least in connection with FIGS. 2 and 3.

In some aspects, the executable journey graph generation system 104 uses the quality evaluation tuning component 122 to tune the performance of the quality evaluation component 118. In some aspects, the quality evaluation tuning component 122 uses original and generated journey graph pairs to adjust the quality evaluation component 118, as described below in connection with FIGS. 2 and 3, tuning the quality evaluation component based on both differences between and similarities between the original and generated journey graph pairs. In some aspects, other methods can be used to tune the quality evaluation component 118. The quality evaluation tuning component 122 can obtain the original and generated journey graph pairs from the data store 126. As described herein, the quality evaluation tuning component 122 is used by, or in conjunction with, a number of other components of the executable journey graph generation system 104 to automatically generate an executable journey graph. Further details of the quality evaluation tuning component 122 are described below, at least in connection with FIGS. 2 and 3.

In some aspects, the executable journey graph generation system 104 uses the custom LLM and uplift model component 124 to generate, store, and provide one or more custom LLM models and/or one or more uplift models that can be used by the journey graph generation component 112 to generate the hybrid journey text and graph representation of a candidate journey graph. As used herein, an LLM is a language model trained on a large corpus of data, and an uplift model is a model used in predicted modelling, which is used in marketing to directly model the incremental impact of an action or treatment on the behavior of an individual user. Further details of how the custom LLM and uplift models are used by the journey graph generation component 112 to generate the hybrid journey text and graph representation of a candidate journey graph are described in connection with FIG. 3. As described herein, the custom LLM and uplift model component 124 is used by, or in conjunction with, a number of other components of the executable journey graph generation system 104 to automatically generate an executable journey graph. Further details of the custom LLM and uplift model component 124 are described below, at least in connection with FIG. 3.

As described below in connection with FIGS. 2 and 3, the executable journey graph generation system 104 typically uses the knowledge graph component and/or the custom LLM and uplift model component 124 to generate the knowledge graph and/or the custom LLM and uplift models separately from the use of the other components to automatically generate an executable journey graph in response to a request from the user interface 110. One workflow to automatically generate an executable journey graph in response to a request from the user interface 110, described in FIG. 2, is for the prompt generation component 120 to use the knowledge graph component 114 to generate a prompt that is sent to the journey graph generation component 112. The journey graph generation component 112 generates a hybrid journey text and graph representation of the desired journey graph and this hybrid journey text and graph representation is sent to the execution formatting component 116. This generates a preliminary executable journey graph that is sent to the quality evaluation component 118. If the preliminary executable journey graph passes a quality threshold, the output of the executable journey graph generation system is the executable journey graph 128. If the preliminary executable journey graph does not pass a quality threshold, a request to regenerate the executable journey graph is sent to the journey graph generation component 112. In some aspects, the executable journey graph 128 is sent, via the network 106, to either the user device 102, the data store 126, or some other such component, not shown in FIG. 1.

Another workflow to automatically generate an executable journey graph in response to a request from the user interface 110, described in FIG. 3, is for the journey graph generation component 112 to use the customer LLM and uplift models provided by the custom LLM and uplift model component 124 to generate the hybrid journey text and graph representation of the desired journey graph. Then, as described above, this hybrid journey text and graph representation is sent to the execution formatting component 116, which generates a preliminary executable journey graph that is sent to the quality evaluation component 118. Again, if the preliminary executable journey graph passes a quality threshold, that executable journey graph 128 is the output of the executable journey graph generation system, and if the preliminary executable journey graph does not pass a quality threshold, a request to regenerate the executable journey graph is sent to the journey graph generation component 112. In some embodiments, an optional step of prompt generation is also used where the prompt generation component 120 uses the knowledge graph component 114 to generate a prompt that is sent to the journey graph generation component 112 which then uses both the custom LLM and uplift model component 124 and the prompt to generate a hybrid journey text and graph representation of the desired journey graph.

FIG. 2 is a block diagram 200 illustrating a workflow for using a knowledge graph to automatically generate an executable journey graph, in accordance with some implementations of the present disclosure. Components of an executable journey graph generation system 202, which is an executable journey graph system such as the executable journey graph generation system 104 described in FIG. 1, are used to implement the workflow for using a knowledge graph to automatically generate an executable journey graph. It should be noted that, unless made clear explicitly or by context, components of the executable journey graph generation system 202 described in connection with FIG. 2 are the same as the same named components described in connection with FIG. 1 so that, for example, the journey graph generation component 220 of FIG. 2 is the same as the journey graph generation component 112 of FIG. 1.

In the example illustrated in FIG. 2, data from a data store 208 is used to generate a knowledge graph, the data comprising historical journey graph data 210 and journey performance indicators 212 (also referred to herein as “journey key performance indicators” or “journey KPI”). A process to extract data to build a knowledge graph 214 is used to extract data and/or metadata from the historical journey graph data 210 and journey performance indicators 212 and generate the knowledge graph. As described above, the knowledge graph stores data and/or metadata about journey entities and the relationships between those entities in an accessible format. It should be noted that, while the process to extract data to build a knowledge graph 214 is shown as separate from the knowledge graph component 216, in some aspects the process to extra data to build a knowledge graph 214 is performed by the knowledge graph component 216. In some aspects, the process to extract data to build a knowledge graph 214 is performed asynchronously from processes to generate an executable journey graph.

In the workflow illustrated in FIG. 2, a user interface 204 is used to provide user inputs and interactions 206 to the executable journey graph generation system 202. In some aspects, not shown in FIG. 2, the user inputs and interactions 206 include an indication to generate an executable journey graph, as described above. This indication causes a prompt generation component 218 to use the knowledge graph component 216, and the knowledge graph therein, to cause a journey graph generation component 220 to generate a hybrid journey text and graph 222. This generated hybrid journey text and graph 222 is provided to an execution formatting component 224 that generates a preliminary executable journey graph 226 by formatting the hybrid journey text and graph 222 as an executable journey graph. This preliminary executable journey graph 226 is also referred to herein as a candidate executable journey graph. A quality evaluation component 232 determines whether the preliminary executable journey graph meets or exceeds a determined quality metric. If, at decision block 234 (labeled as “GOOD?”), the quality evaluation component 232 determines that the preliminary executable journey graph meets or exceeds a determined quality metric (the “YES” branch), the preliminary executable journey graph is provided as output from the executable journey graph generation system 202 as an executable journey graph 238. If, at decision block 234, the quality evaluation component 232 determines that the preliminary executable journey graph does not meet or exceed the determined quality metric (the “NO” branch), an indication to regenerate the journey graph 236 is sent to the journey graph generation component 220.

In the example illustrated in FIG. 2, original and generated journey graph pairs 228 are obtained from the data store 208 by a quality evaluation tuning component 230, which uses the original and generated journey graph pairs 228 to tune the functionality of the quality evaluation component 232, by improving the functionality of the quality evaluation component 232, by adjusting metrics used by the quality evaluation component 232 to determine the quality of the preliminary executable journey graph 226, by adjusting the threshold of the quality evaluation component 232, or by a combination of these and/or other such tuning actions.

FIG. 3 is a block diagram 300 illustrating a workflow for using a custom large language model and/or an uplift model to automatically generate an executable journey graph, in accordance with some implementations of the present disclosure. Components of an executable journey graph generation system 302, which is an executable journey graph system such as the executable journey graph generation system 104 described in FIG. 1, are used to implement the workflow for using a custom large language model and/or an uplift model to automatically generate an executable journey graph. It should be noted that, unless made clear explicitly or by context, components of the executable journey graph generation system 302 described in connection with FIG. 3 are the same as the same named components described in connection with FIG. 1 so that, for example, the journey graph generation component 320 of FIG. 3 is the same as the journey graph generation component 112 of FIG. 1.

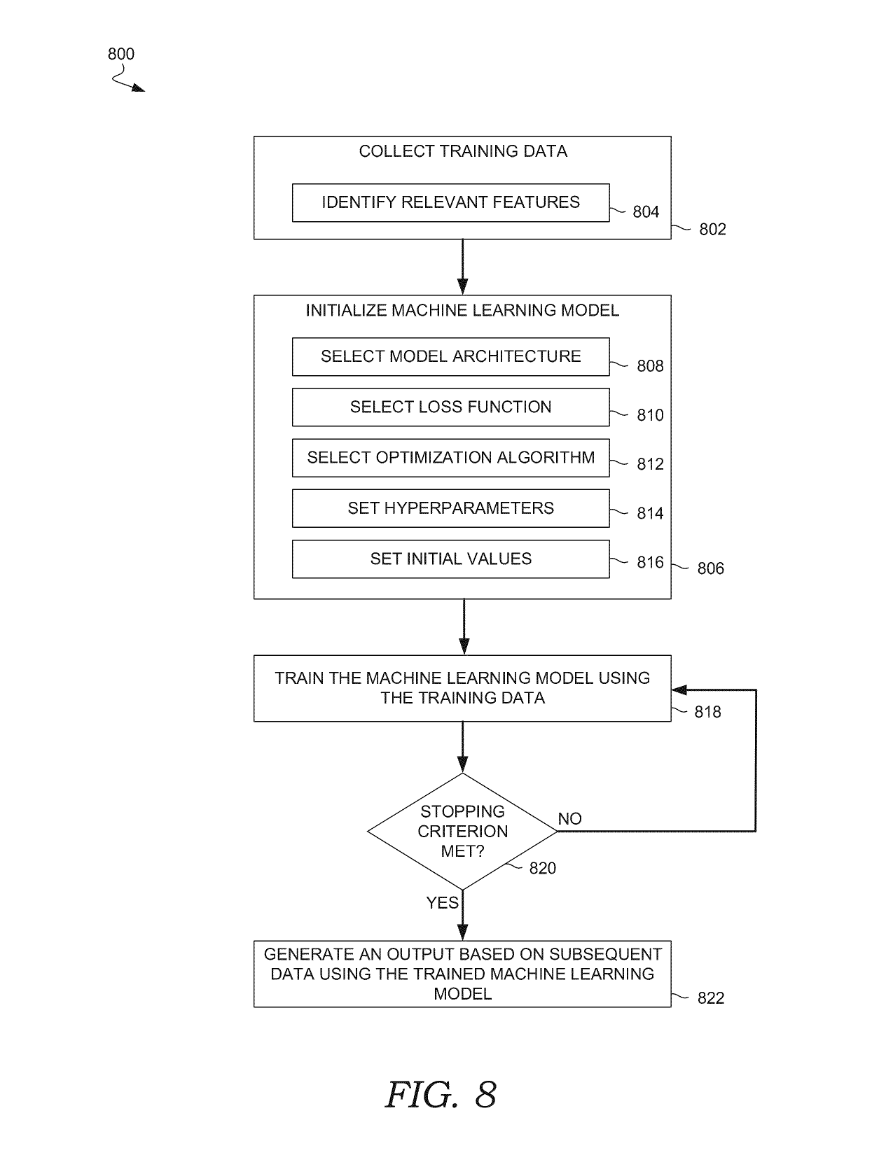

In the example illustrated in FIG. 3, data from a data store 308 is used to generate a custom LLM and an uplift model, the data comprising historical journey graph data 310 and in-journey behavior data 312. The in-journey behavior data 312 is data about how users progress through a particular journey graph. A process to train and deploy custom LLM and uplift models 340 is used to extract data and/or metadata from the historical journey graph data 310 and the in-journey behavior data 312 and generate the custom LLM and uplift models 340 using systems and methods described herein at least in connection with FIG. 8. The custom LLM and uplift models are used by the journey graph generation component 320 to generate the hybrid journey text and graph 322, described below. It should be noted that, while the process to train and deploy custom LLM and uplift models 340 is shown as separate from the custom LLM and uplift model component 342, in some aspects, the process to train and deploy custom LLM and uplift models 340 is performed by the custom LLM and uplift model component 342. In some aspects, the process to train and deploy custom LLM and uplift models 340 is performed asynchronously from processes to generate an executable journey graph.

In the example illustrated in FIG. 3, data from a data store 308 is also used to generate a knowledge graph, the data comprising historical journey graph data 310 and in-journey behavior data 312. A process to extract data to build the knowledge graph 314 is used to extract data and/or metadata from the historical journey graph data 310 and the in-journey behavior data 312 and generate the knowledge graph. The knowledge graph stores data and/or metadata about journey entities and the relationships between those entities in an accessible format. It should be noted that, while the process to extract data to build a knowledge graph 314 is shown as separate from the knowledge graph component 316, in some aspects, the process to extra data to build a knowledge graph 314 is performed by the knowledge graph component 316. In some aspects, the process to extract data to build a knowledge graph 314 is performed asynchronously from processes to generate an executable journey graph. As described below, the process to extract data to build the knowledge graph 314 and/or the knowledge graph component 316 is optional in the workflow for using a custom large language model and/or an uplift model to automatically generate an executable journey graph illustrated in FIG. 3, as indicated by the dashed lines.

In the workflow illustrated in FIG. 3, a user interface 304 is used to provide user inputs and interactions 306 to the executable journey graph generation system 302. In some aspects, not shown in FIG. 3, the user inputs and interactions 306 include an indication to generate an executable journey graph, as described above. This indication causes a journey graph generation component 320 to generate a hybrid journey text and graph 322 using the custom LLM and uplift models provided by the custom LLM and uplift component 342. In some aspects, the journey graph generation component 320 also uses the prompt generation component 318 to generate a hybrid journey text and graph 322, using the knowledge graph component 316, as described in connection with FIG. 2. As with the process to extract data to build a knowledge graph 314 and the knowledge graph component 316, the use of the prompt generation component 318 by the journey graph component 320 to generate a hybrid journey text and graph 322 is optional in the workflow for using a custom large language model and/or an uplift model to automatically generate an executable journey graph illustrated in FIG. 3, as indicated by the dashed lines.

This generated hybrid journey text and graph 322 is provided to an execution formatting component 324 that generates a preliminary executable journey graph 326 by formatting the hybrid journey text and graph 322 as an executable journey graph. This preliminary executable journey graph 326 is also referred to herein as a candidate executable journey graph. A quality evaluation component 332 determines whether the preliminary executable journey graph meets or exceeds a determined quality metric. If, at decision block 334 (labeled as “GOOD?”), the quality evaluation component 332 determines that the preliminary executable journey graph meets or exceeds a determined quality metric (the “YES” branch), the preliminary executable journey graph is provided as output from the executable journey graph generation system 302 as an executable journey graph 338. If, at decision block 334, the quality evaluation component 332 determines that the preliminary executable journey graph does not meet or exceed the determined quality metric (the “NO” branch), an indication to regenerate the journey graph 336 is sent to the journey graph generation component 320.

In the example illustrated in FIG. 3, original and generated journey graph pairs 328 are obtained from the data store 308 by a quality evaluation tuning component 330, which uses the original and generated journey graph pairs 328 to tune the functionality of the quality evaluation component 332, by improving the functionality of the quality evaluation component 332, by adjusting metrics used by the quality evaluation component 332 to determine the quality of the preliminary executable journey graph 326, by adjusting the threshold of the quality evaluation component 332, or by a combination of these and/or other such tuning actions.

In some aspects, the process to extract data to build the knowledge graph 314, the knowledge graph component 316, and the prompt generation component 318 are optional in the workflow for using a custom large language model and/or an uplift model to automatically generate an executable journey graph illustrated in FIG. 3 (as indicated by the dashed lines). These optional components and/or operations can be performed in conjunction with the operations by the journey graph component 320 that use the custom LLM and uplift model provided by the custom LLM and uplift model component 342 to generate the hybrid journey text and graph 322. These optional components and/or operations can also not be performed in conjunction with the operations by the journey graph component 320 so that the journey graph generation component 320 only uses the custom LLM and uplift model provided by the custom LLM and uplift model component 342 to generate the hybrid journey text and graph 322.

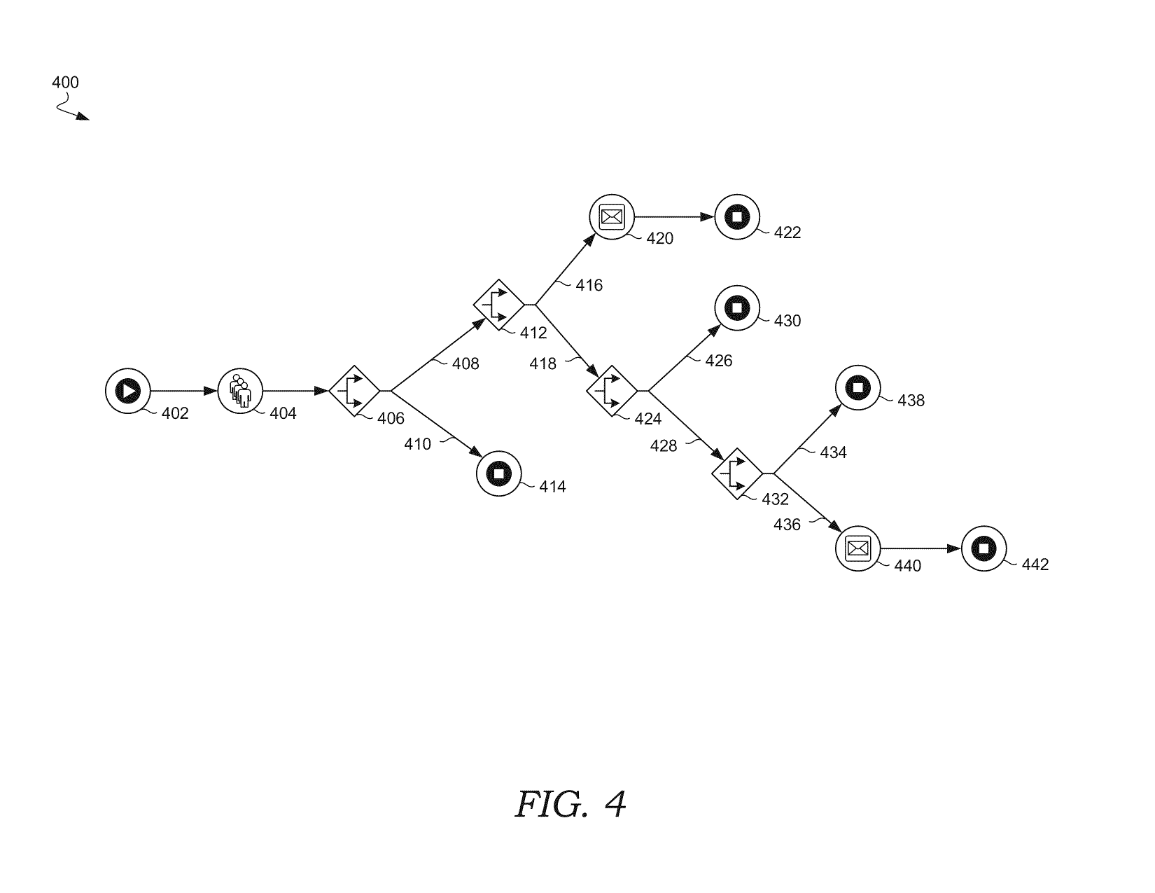

FIG. 4 is a block diagram 400 illustrating an example journey graph, in accordance with some implementations of the present disclosure. The journey graph illustrated in FIG. 4 includes a variety of node types where nodes of a particular node type are connected by directional edges, forming a directed acyclic graph (DAG) usable for journey orchestration. Example node types include condition nodes, which segment groups of users by defined criteria, triggered condition nodes, which are activated by events such as website visits or email opens, message nodes, which facilitate communication through various channels (email, messaging, push notifications, etc.), wait nodes, which control timing between journey stages, decision nodes, which apply rules or machine learning models to determine a best path through the journey, and control nodes, such as start or end nodes. As may be contemplated, other node types may be considered as being within the scope of the present disclosure.

The example journey graph illustrated in FIG. 4 is generated for a journey that starts by reading the segment for audiences of a specific type and checks if today is Aug. 27 and, if it is, verifies that the user is on the corresponding list. For the first list, the journey checks if the user is subscribed and has opted in for marketing emails, and if so, sends the user a first email. For the second list, the journey directly sends a second, different email. If the conditions are not met, the journey ends. The example illustrated in FIG. 4 is an example of a manually generated journey graph.

The example journey graph illustrated in FIG. 4 begins with a start node 402 and is followed by a node 404 to select the population of users that are in one group or the other. Next is a decision node 406 that determines whether the date is Aug. 27. If the date is not Aug. 27, the journey graph branches 410 to an end node 414. If the date is Aug. 27, the journey graph branches 408 to another decision node 412, which determines whether the user is in the first group or the second group. If the user is in the second group, the journey graph branches 416 to a message node 420, which causes the second email to be sent to the user and, following that, the journey graph continues to an end node 422. If, at decision node 412, the user is in the first group, the journey graph branches 418 to a decision node 424 that determines if the user is subscribed. If the user is not subscribed, the journey graph branches 426 to an end node 430. If the user is subscribed, the journey graph branches 428 to another decision node 432 that determines if the user has opted in. Again, if the user has not opted in, the journey graph branches 434 to an end node 438. If the user has opted in, the journey graph branches 436 to a message node 440, which causes the first email to be sent to the user and, following that, the journey graph continues at an end node 442. Each of the end nodes illustrated in FIG. 4 (end node 414, end node 422, end node 430, end node 438, and end node 442) cause the journey graph to terminate, completing the journey.

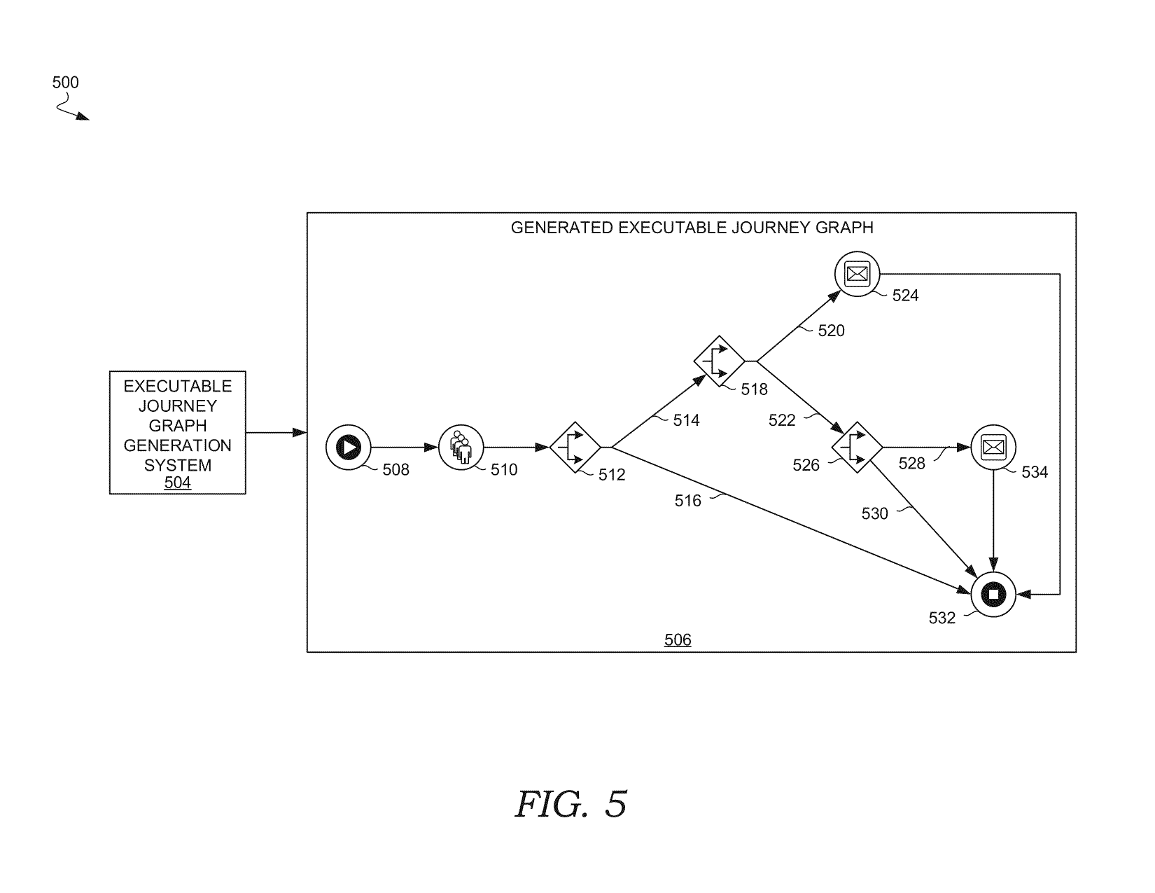

FIG. 5 is a block diagram 500 illustrating an example automatically generated executable journey graph 506, in accordance with some implementations of the present disclosure. The example automatically generated executable journey graph 506 includes a variety of node types as described above. The example automatically generated executable journey graph 506 is automatically generated by an executable journey graph generation system 504, which is an executable journey graph generation system such as executable journey graph generation system 104. The example automatically generated executable journey graph 506 is generated in response to a prompt to “generate a journey that starts by reading the segment for audiences of a specific type and checks if today is Aug. 27 and, if it is, verifies that the user is on the corresponding list. For the first list, the journey checks if the user is subscribed and has opted in for marketing emails, and if so, sends the user a first email. For the second list, the journey directly sends a second, different email. If the conditions are not met, the journey ends.”

The example automatically generated executable journey graph 506, begins with a start node 508 and is followed by a node 510 to select the population of users that are in one group or the other. Next is a decision node 512 that determines whether the date is Aug. 27. If the date is not Aug. 27, the example automatically generated executable journey graph 506 branches 516 to an end node 532. If the date is Aug. 27, the example automatically generated executable journey graph 506 branches 514 to another decision node 518, which determines whether the user is in the first group or the second group. If the user is in the second group, the example automatically generated executable journey graph 506 branches 520 to a message node 524, which causes the second email to be sent to the user and, following that, the example automatically generated executable journey graph 506 finishes at the end node 532. If, at decision node 518, the user is in the first group, the example automatically generated executable journey graph 506 branches 522 to a decision node 526 that determines if the user is subscribed and has opted in. If the user is not subscribed or has not opted in, the example automatically generated executable journey graph 506 branches 530 to the end node 532. If the user is subscribed and has opted in, the example automatically generated executable journey graph 506 branches 528 to a message node 534, which causes the first email to be sent to the user and, following that, the example automatically generated executable journey graph 506 continues at the end node 532. In the example illustrated in FIG. 5, the example automatically generated executable journey graph 506 has combined the various end nodes of FIG. 4 (end node 414, end node 422, end node 430, end node 438, and end node 442) into a single end node 532 and has also combined the multiple decision nodes in FIG. 4 for determining whether the user has subscribed and opted in (decision node 424 and decision node 432) into a single decision node 526, yielding a more efficient journey graph.

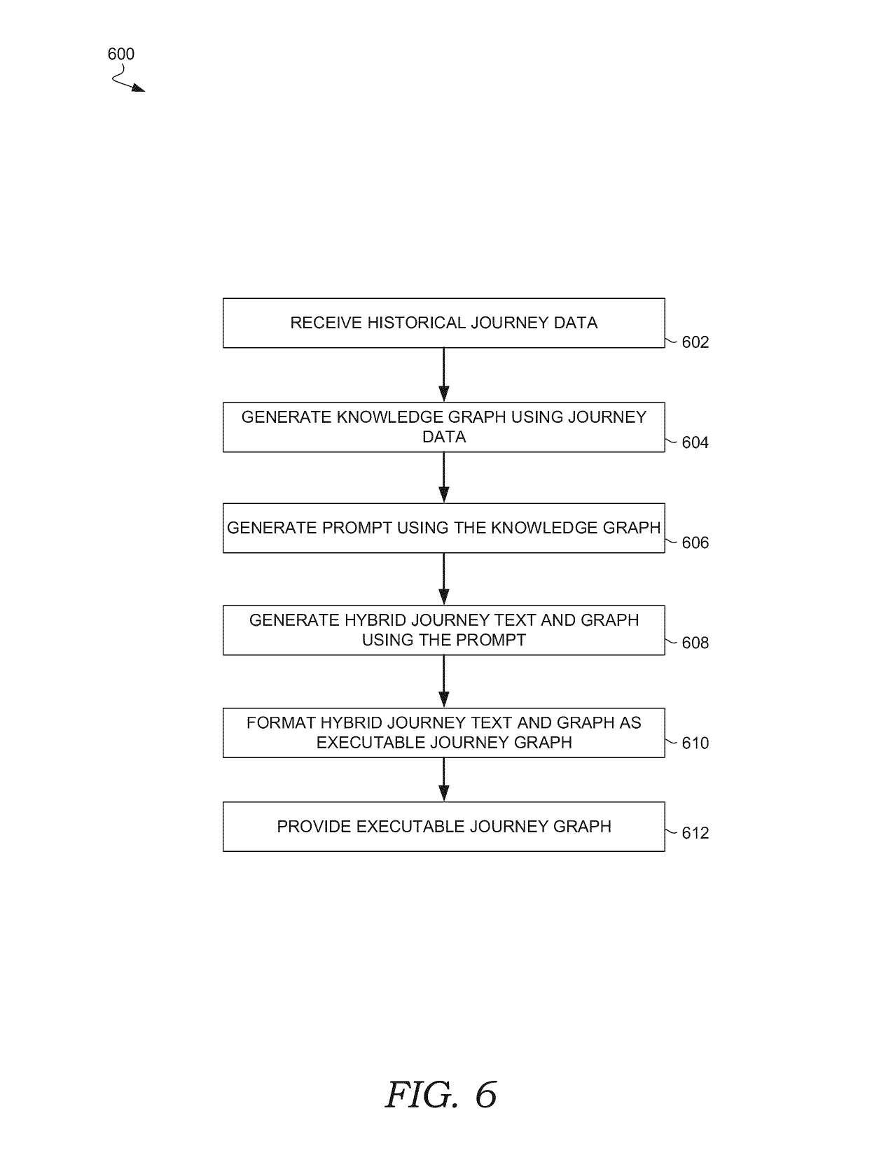

FIG. 6 is a flow diagram showing an example process for automatically generating a journey graph, in accordance with some implementations of the present disclosure. The process (or method) illustrated in FIG. 6 is performed by, for instance, the executable journey graph generation system 104 described herein at least in connection with FIG. 1. Each block of the process (or method) illustrated in FIG. 6 and any other processor or methods described herein comprises a computing process performed using any combination of hardware, firmware, and/or software. For instance, various functions are carried out by a processor executing instructions stored in memory. The processes or methods can also be embodied as computer-usable instructions stored on computer storage media. The processes or methods can be provided by a standalone application, a service or hosted service (standalone or in combination with another hosted service), a plug-in to another product, or other such applications, services, products, or plug-ins.

At block 602, a processing device implementing aspects of the present disclosure performs operations to receive historical journey data. In some aspects, the historical journey data comprises historical journey graph data 210 that is obtained from data store 208. In some aspects, the historical journey graph data comprises journey performance indicators 212 that are also obtained from data store 208. In some aspects, after block 602, the process illustrated in FIG. 6 continues at block 604.

At block 604, a processing device implementing aspects of the present disclosure performs operations to generate a knowledge graph using the historical journey data obtained at block 602. In some aspects, the operations to generate the knowledge graph using the historical journey data obtained at block 602 are performed by a knowledge graph component 216. In some aspects, after block 604, the process illustrated in FIG. 6 continues at block 606.

At block 606, a processing device implementing aspects of the present disclosure performs operations to generate a prompt using the knowledge graph generated at block 604. In some aspects, the operations to generate the prompt using the knowledge graph generated at block 604 are performed by a prompt generation component 218. In some aspects, after block 606, the process illustrated in FIG. 6 continues at block 608.

At block 608, a processing device implementing aspects of the present disclosure performs operations to generate a hybrid journey text and graph using the prompt generated at block 606. In some aspects, the operations to generate the hybrid journey text and graph using the prompt generated at block 606 are performed by a journey graph generation component 220, and the operations generate a hybrid journey text and graph such as hybrid journey text and graph 222. In some aspects, after block 608, the process illustrated in FIG. 6 continues at block 610.

At block 610, a processing device implementing aspects of the present disclosure performs operations to format the hybrid journey text and graph generated at block 608 as a preliminary executable journey graph. In some aspects, the operations to format the hybrid journey text and graph generated at block 608 as an executable journey graph are performed by an execution formatting component 224 and the operations generate a preliminary executable journey graph such as preliminary executable journey graph 226. In some aspects, after block 610, the process illustrated in FIG. 6 continues at block 612.

In some aspects, not shown in FIG. 6, after block 610, a processing device implementing aspects of the present disclosure performs operations to evaluate the quality of the preliminary executable journey graph generated at block 610 and the process illustrated in FIG. 6 only continues at block 612 if the preliminary executable journey graph generated at block 610 meets or exceeds a determined quality threshold. In such aspects, if the preliminary executable journey graph generated at block 610 does not meet or exceed the determined quality threshold, the process illustrated in FIG. 6 continues at block 608, to generate a new hybrid journey text and graph using the prompt generated at block 606.

At block 612, a processing device implementing aspects of the present disclosure performs operations to provide the executable journey graph using, for example, a user interface 204. In some aspects, after block 612, the process illustrated in FIG. 6 terminates. In some aspects, not shown in FIG. 6, after block 612, the process illustrated in FIG. 6 continues at block 602 to receive additional historical data and proceeds to block 604, to generate or regenerate the knowledge graph. In some aspects, not shown in FIG. 6, after block 612, the process illustrated in FIG. 6 continues at block 606, to generate a new prompt using the previously generated knowledge graph and proceeds to block 608 to generate a new hybrid journey text and graph using the new prompt generated at block 606.

Although not illustrated in FIG. 6, in some configurations, the operations of the process illustrated in FIG. 6 are performed in a different order than that described. In some configurations, where operations are performed in a different order, some of the operations are performed in parallel by a plurality of devices such as those described herein, using a plurality of threads. As may be contemplated, other orders in which to perform the operations illustrated in flow diagram 600 may be considered as being within the scope of the present disclosure.

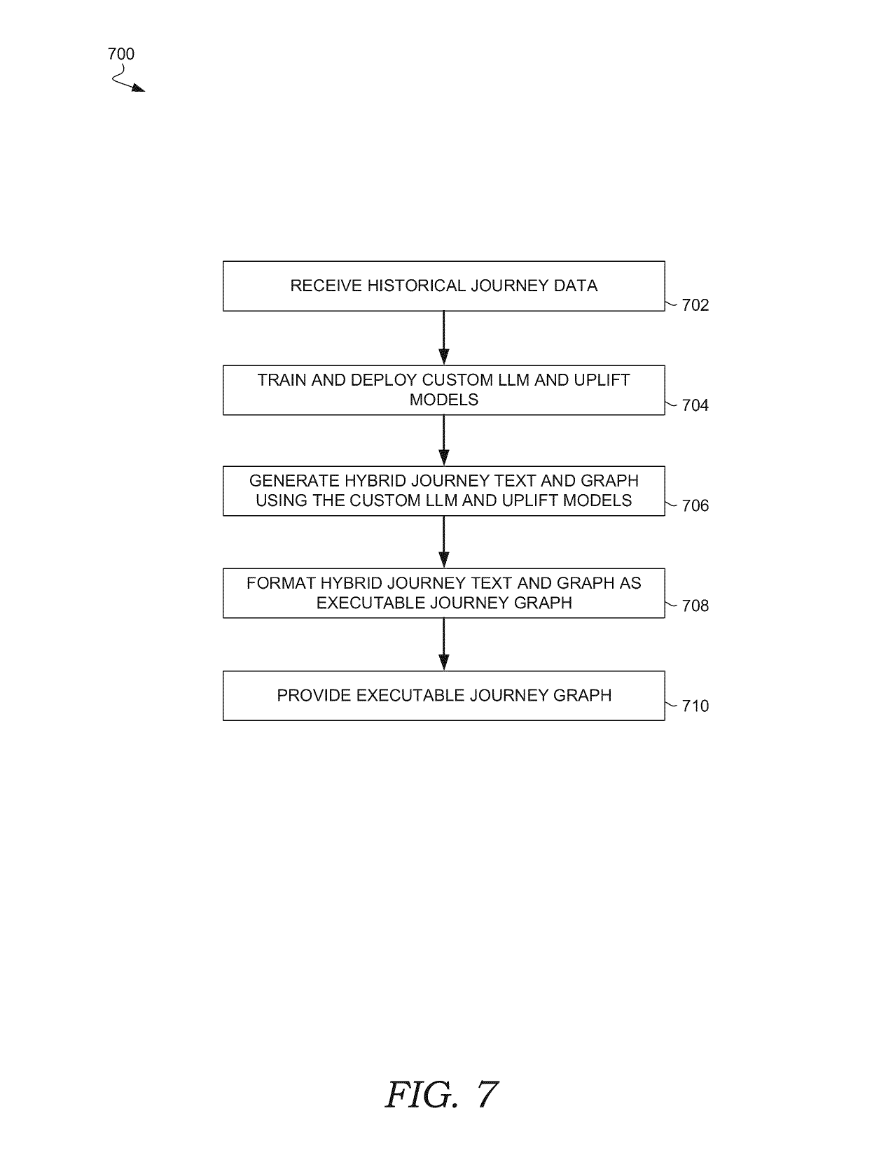

FIG. 7 is a flow diagram showing an example process for automatically generating a journey graph, in accordance with some implementations of the present disclosure. The process (or method) illustrated in FIG. 7 is performed by, for instance, the executable journey graph generation system 104 described herein at least in connection with FIG. 1. Each block of the process (or method) illustrated in FIG. 7 and any other processor or methods described herein comprises a computing process performed using any combination of hardware, firmware, and/or software. For instance, various functions are carried out by a processor executing instructions stored in memory. The processes or methods can also be embodied as computer-usable instructions stored on computer storage media. The processes or methods can be provided by a standalone application, a service or hosted service (standalone or in combination with another hosted service), a plug-in to another product, or other such applications, services, products, or plug-ins.

At block 702, a processing device implementing aspects of the present disclosure performs operations to receive historical journey data. In some aspects, the historical journey data comprises historical journey graph data 310 that is obtained from data store 308. In some aspects, the historical journey graph data comprises in-journey behavior data 312 that is also obtained from data store 308. In some aspects, after block 702, the process illustrated in FIG. 7 continues at block 704.

At block 704, a processing device implementing aspects of the present disclosure performs operations to train and deploy custom LLM and uplift models using the historical data obtained at block 702. In some aspects, the operations to train and deploy custom LLM and uplift models using the historical data obtained at block 702 are performed by a custom LLM and uplift model component 342. In some aspects, after block 704, the process illustrated in FIG. 7 continues at block 706.

At block 706, a processing device implementing aspects of the present disclosure performs operations to generate a hybrid journey text and graph using the custom LLM and uplift models trained and deployed at block 704. In some aspects, the operations to generate the hybrid journey text and graph using the custom LLM and uplift models trained and deployed at block 704 are performed by a journey graph generation component 320 and the operations generate a hybrid journey text and graph such as hybrid journey text and graph 322. In some aspects, before block 706, a processing device implementing aspects of the present disclosure performs operations to generate a knowledge graph using the historical journey data obtained at block 702, and performs operations to generate a prompt using the generated knowledge graph. In such aspects, the operations to generate the knowledge graph using the historical journey data obtained at block 702 are performed by a knowledge graph component 316 and the operations to generate the prompt using the generated knowledge graph are performed by a prompt generation component 318. In such aspects, the operations of block 706 to generate a hybrid journey text and graph using the custom LLM and uplift models trained and deployed at block 704 also uses a prompt from the prompt generation component 318 to perform such generation. In some aspects, after block 706, the process illustrated in FIG. 7 continues at block 708.

At block 708, a processing device implementing aspects of the present disclosure performs operations to format the hybrid journey text and graph generated at block 706 as a preliminary executable journey graph. In some aspects, the operations to format the hybrid journey text and graph generated at block 706 as an executable journey graph are performed by an execution formatting component 324 and the operations generate a preliminary executable journey graph such as preliminary executable journey graph 326. In some aspects, after block 708, the process illustrated in FIG. 7 continues at block 710.

In some aspects, not shown in FIG. 7, after block 708, a processing device implementing aspects of the present disclosure performs operations to evaluate the quality of the preliminary executable journey graph generated at block 708 and the process illustrated in FIG. 7 only continues at block 710 if the preliminary executable journey graph generated at block 708 meets or exceeds a determined quality threshold. In such aspects, if the preliminary executable journey graph generated at block 708 does not meet or exceed the determined quality threshold, the process illustrated in FIG. 7 continues at block 706, to generate a new hybrid journey text and graph using the custom LLM and uplift models trained and deployed at block 704.

At block 710, a processing device implementing aspects of the present disclosure performs operations to provide the executable journey graph using, for example, a user interface 304. In some aspects, after block 710, the process illustrated in FIG. 7 terminates. In some aspects, not shown in FIG. 7, after block 710, the process illustrated in FIG. 7 continues at block 702 to receive additional historical data and proceeds to block 704, to train and deploy new or updated custom LLM and uplift models. In some aspects, not shown in FIG. 7, after block 710, the process illustrated in FIG. 7 continues at block 706, to generate a new hybrid journey text and graph using the previously trained and updated custom LLM and uplift models.

Although not illustrated in FIG. 7, in some configurations, the operations of the process illustrated in FIG. 7 are performed in a different order than that described. In some configurations, where operations are performed in a different order, some of the operations are performed in parallel by a plurality of devices such as those described herein, using a plurality of threads. As may be contemplated, other orders in which to perform the operations illustrated in flow diagram 700 may be considered as being within the scope of the present disclosure.

### Training: Machine Learning

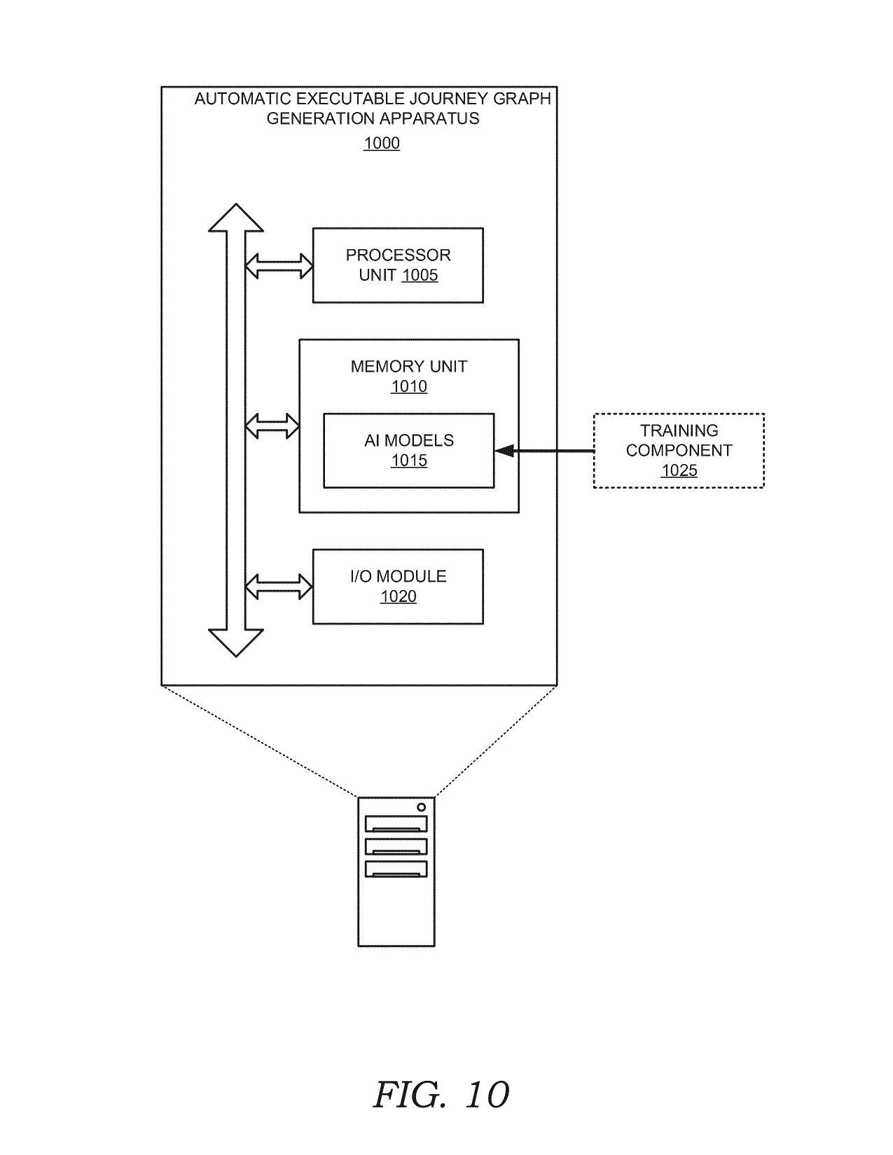

FIG. 8 is a flow diagram depicting an algorithm as a step-by-step procedure 800 in an example implementation of operations performable for training a machine-learning model, in accordance with some implementations of the present disclosure. In some embodiments, the procedure 800 describes an operation of the training component 1025 described for configuring the AI models 1015 as described with reference to FIG. 10. The procedure 800 provides one or more examples of generating training data, use of the training data to train a machine-learning model, and use of the trained machine-learning model to perform a task.

To begin in this example, a machine-learning system collects training data (block 802) that is to be used as a basis to train a machine-learning model, which defines what is being modeled. The training data is collectable by the machine-learning system from a variety of sources. Examples of training data sources include public datasets, service provider system platforms that expose application programming interfaces (for example, social media platforms), user data collection systems (for example, digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 804) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 806). Initialization of the machine-learning model includes selecting a model architecture (block 808) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 810). The loss function is utilized to measure a difference between an output of the machine-learning model (in other words, to make predictions) and target values (for example, as expressed by the training data) to be used to train the machine-learning model. Additionally, an optimization algorithm is selected (812) that is to be used in conjunction with the loss function to optimize parameters of the machine-learning model during training, examples of which include gradient descent, stochastic gradient descent (SGD), and so forth.

Initialization of the machine-learning model further includes setting hyperparameters of the of the machine-learning model (block 814) and setting initial values of the machine-learning model (block 816) examples of which includes initializing weights and biases of nodes to improve efficiency in training and computational resources consumption as part of training. At block 814, hyperparameters are also set that are used to control training of the machine learning model, examples of which include regularization parameters, model parameters (for example, a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 818) by the machine-learning system. A machine-learning model refers to a computer representation that can be tuned (for example, trained and retrained) based on inputs of the training data to approximate unknown functions. In particular, the term machine-learning model can include a model that utilizes algorithms (for example, using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (for example, rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, for example, through use of the selected loss function and backpropagation to optimize performance of the machine-learning model to perform an associated task.

As part of training the machine-learning model, a determination is made as to whether a stopping criterion is met (decision block 820), which is used to validate the machine-learning model. The stopping criterion is usable to reduce overfitting of the machine-learning model, reduce computational resource consumption, and promote an ability of the machine-learning model to address previously unseen data (data that is not included specifically as an example in the training data). Examples of a stopping criterion include but are not limited to a predefined number of epochs, validation loss stabilization, and achievement of a performance improvement threshold, whether a threshold level of accuracy has been met, or based on performance metrics such as precision and recall. If the stopping criterion has not been met (“NO” from decision block 820), the procedure 800 continues training of the machine-learning model using the training data (block 818) in this example.

If the stopping criterion is met (“YES” from decision block 820), the trained machine-learning model is then utilized to generate an output based on subsequent data (block 822). The trained machine-learning model, for instance, is trained to perform a task as described above and therefore once trained is configured to perform that task based on subsequent data received as an input and processed by the machine-learning model.

### System: Computing Device

FIG. 9 shows an example of a computing device 900, in accordance with some implementations of the present disclosure. The computing device 900 may be an example of the automatic executable journey graph generation apparatus 1000 described with reference to FIG. 10. In one aspect, computing device 900 includes processor(s) 905, memory subsystem 910, communication interface 915, I/O interface 920, user interface component(s) 925, and channel 930.

In some embodiments, computing device 900 includes one or more processors 905 that can execute instructions stored in memory subsystem 910 to perform media generation. According to some aspects, computing device 900 includes one or more processors 905. In some cases, a processor is an intelligent hardware device, (for example, a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 910 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 915 operates at a boundary between communicating entities (such as computing device 900, one or more user devices, a cloud, and one or more databases) and channel 930 and can record and process communications. In some cases, communication interface 915 is provided to enable a processing system coupled to a transceiver (for example, a transmitter and/or a receiver). In some examples, the transceiver is configured to transmit (or send) and receive signals for a communications device via an antenna.

According to some aspects, I/O interface 920 is controlled by an I/O controller to manage input and output signals for computing device 900. In some cases, I/O interface 920 manages peripherals not integrated into computing device 900. In some cases, I/O interface 920 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 920 or via hardware components controlled by the I/O controller.

According to some aspects, user interface component(s) 925 enable a user to interact with computing device 900. In some cases, user interface component(s) 925 include an audio device, such as an external speaker system, an external display device such as a display screen, an input device (for example, a remote-control device interfaced with a user interface directly or through the I/O controller), or a combination thereof. In some cases, user interface component(s) 925 include a GUI.

### SYSTEM: AUTOMATIC EXECUTABLE JOURNEY GRAPH GENERATION APPARATUS

FIG. 10 shows an example of an automatic executable journey graph generation apparatus 1000, in accordance with some implementations of the present disclosure. Automatic executable journey graph generation apparatus 1000 may include an example of, or aspects of, the various artificial intelligence and/or other such models including those described herein. In some embodiments, automatic executable journey graph generation apparatus 1000 includes processor unit 1005, memory unit 1010, one or more artificial intelligence models (AI models 1015), I/O module 1020, and training component 1025. Training component 1025 updates parameters of the AI models 1015 stored in memory unit 1010. In some examples, the training component 1025 is located outside the automatic executable journey graph generation apparatus 1000.

Processor unit 1005 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1005 is configured to operate a memory array using a memory controller. In other cases, a memory controller is integrated into processor unit 1005. In some cases, processor unit 1005 is configured to execute computer-readable instructions stored in memory unit 1010 to perform various functions. In some aspects, processor unit 1005 includes special purpose components for modem processing, baseband processing, digital signal processing, or transmission processing. According to some aspects, processor unit 1005 comprises one or more processors described with reference to FIG. 9.

Memory unit 1010 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1005 to perform various functions described herein.

In some cases, memory unit 1010 includes a basic input/output system (BIOS) that controls basic hardware or software operations, such as an interaction with peripheral components or devices. In some cases, memory unit 1010 includes a memory controller that operates memory cells of memory unit 1010. For example, the memory controller may include a row decoder, column decoder, or both. In some cases, memory cells within memory unit 1010 store information in the form of a logical state. According to some aspects, memory unit 1010 is an example of the memory subsystem 910 described with reference to FIG. 9.

According to some aspects, automatic executable journey graph generation apparatus 1000 uses one or more processors of processor unit 1005 to execute instructions stored in memory unit 1010 to perform functions described herein. For example, the automatic executable journey graph generation apparatus 1000 may perform operations described with respect to FIGS. 6 and 7 to automatically generate an executable journey graph.

The memory unit 1010 may include one or more AI models 1015 trained to be used by an executable journey graph generation system 104 to perform operations described with respect to FIGS. 6 and 7 to automatically generate an executable journey graph. For example, after training, the AI models 1015 may perform inferencing operations to do perform such operations.

In some embodiments, the AI models 1015 are artificial neural network (ANN) models such as large language models, knowledge graphs, and/or uplift models. These models can be hardware components or software components that include connected nodes or artificial neurons that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network’s ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of AI models 1015 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1025 may train the AI models 1015. For example, parameters of the AI models 1015 can be learned or estimated from training data and then used to make predictions or perform tasks based on learned patterns and relationships in the data. In some examples, the parameters are adjusted during the training process to minimize a loss function or maximize a performance metric. The goal of the training process may be to find optimal values for the parameters that allow the machine learning model to make accurate predictions or perform well on the given task.

Accordingly, the node weights can be adjusted to improve the accuracy of the output by, for example, minimizing a loss which corresponds in some way to the difference between the current result and the target result. The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the AI models 1015 can be used to make predictions on new, unseen data such as during inferencing operations.

I/O module 1020 receives inputs from and transmits outputs of the automatic executable journey graph generation apparatus 1000 to other devices or users. For example, I/O module 1020 receives inputs for the AI models 1015 and transmits outputs of the AI models 1015. According to some aspects, I/O module 1020 is an example of the I/O interface 920 described with reference to FIG. 9.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (for example, machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. A computer system comprising:
one or more processors; and
one or more computer storage media storing computer-useable instructions that, when used by the one or more processors, causes the computer system to perform operations comprising:
receiving, at a journey graph generation component, journey graph data;
generating, by the journey graph generation component, a first representation of a journey graph using the journey graph data, the first representation comprising a hybrid journey text and graph, the first representation generated using one or more AI models;
formatting, using an execution formatting component, the first representation to generate an executable journey graph; and
providing the executable journey graph for execution by the computer system.

2. The computer system of claim 1, wherein the one or more AI models comprise a knowledge graph provided by a knowledge graph component, the knowledge graph generated using historical journey graph data and journey performance indicators.

3. The computer system of claim 2, wherein the operations further comprise:
generating, using a prompt generation component, a prompt, the prompt based, at least in part, on the knowledge graph; and
generating the first representation of the journey graph based, at least in part, on the prompt.

4. The computer system of claim 1, wherein the operations further comprise:
receiving, at the journey graph generation component, user inputs and interactions; and
generating the first representation of the journey graph based, at least in part, on the user inputs and interactions.

5. The computer system of claim 1, wherein the operations further comprise:
receiving, at a quality evaluation component, the executable journey graph;
determining, using the quality evaluation component, whether the executable journey graph meets or exceeds a determined quality threshold; and
as a result of determining that the executable journey graph meets or exceeds the determined quality threshold, providing the executable journey graph for execution by the computer system.

6. The computer system of claim 1, wherein the one or more AI models comprise a large language model (LLM) and an uplift model, the LLM and the uplift model trained and deployed by a custom LLM and uplift model component, the LLM and the uplift model trained and deployed using historical journey graph data and in-journey behavior data.

7. The computer system of claim 1, wherein the operations further comprise:
storing the executable journey graph in a data store;
comparing the executable journey graph to one or more previously generated journey graphs; and
providing an indication of a quality of the executable journey graph based, at least in part, on comparing the executable journey graph to the one or more previously generated journey graphs.

8. The computer system of claim 7, wherein the operations further comprise tuning, by a quality evaluation tuning component, a quality evaluation component based, at least in part, on the indication of the quality of the executable journey graph.

9. The computer system of claim 1, wherein the operations further comprise:
updating the one or more AI models based, at least in part, on performance insights that are derived from analyzing user interactions with the executable journey graph.

10-20. (canceled)

21. A computer-implemented method comprising:
receiving, at a knowledge graph component, journey graph data;
generating, using the knowledge graph component, a knowledge graph, the knowledge graph generated using the journey graph data;
generating, by a journey graph generation component, a first representation of a journey graph, the first representation comprising a hybrid journey text and graph, the first representation generated based on a prompt to the journey graph generation component;
formatting, using an execution formatting component, the first representation of the journey graph to generate an executable journey graph; and
providing the executable journey graph using a user interface.

22. The computer-implemented method of claim 21, wherein the journey graph data comprises historical journey graph data and journey performance indicators.

23. The computer-implemented method of claim 21, wherein the prompt to the journey graph generation component is generated by a prompt generation component, the prompt based on contents of the knowledge graph.

24. The computer-implemented method of claim 21, further comprising:
executing the executable journey graph using a multi-channel marketing system.

25. The computer-implemented method of claim 21, wherein the prompt to the journey graph generation component is a few-shots prompt.

26. The computer-implemented method of claim 21, wherein the first representation is generated based on user inputs and interactions.

2727 One or more computer storage media storing computer-useable instructions that, when used by one or more computing devices, cause the one or more computing devices to perform operations, the operations comprising:
receiving journey graph data;
generating a first representation of a journey graph, the first representation comprising a hybrid journey text and graph, the first representation generated based on a large language model and an uplift model;
formatting the first representation to generate an executable journey graph; and
providing the executable journey graph using a user interface.

28. The one or more computer storage media of claim 27, the operations further comprising:
training the large language model using the journey graph data; and
training the uplift model using the journey graph data.

2929 The one or more computer storage media of claim 27, wherein the operations further comprise:
providing the executable journey graph to a journey planning system; and
executing the executable journey graph using the journey planning system.

30. The one or more computer storage media of claim 27, wherein the operations further comprise:
receiving, at a knowledge graph component, the journey graph data;
generating, using a knowledge graph component, a knowledge graph, the knowledge graph generated using the journey graph data;
generating, by a prompt generation component, a prompt to generate an executable journey graph, the prompt based on the knowledge graph; and
generating the first representation based on the prompt.

31. The one or more computer storage media of claim 27, wherein the operations further comprise:
receiving, at a quality evaluation component, the executable journey graph;
determining, using the quality evaluation component, whether the executable journey graph meets or exceeds a determined quality threshold; and
as a result of determining that the executable journey graph meets or exceeds the determined quality threshold, providing the executable journey graph using the user interface.
